(19) United States
(12) Patent Application Publication
(10) Pub. No.: US 2022/0075283 A1
(43) Pub. Date: Mar. 10, 2022

(54) TONER, TONER CARTRIDGE, AND IMAGE FORMING APPARATUS

(71) Applicant: TOSHIBA TEC KABUSHIKI KAISHA, Tokyo (JP)

(72) Inventor: Shunsuke AOKI, Sunto Shizuoka (JP)

(73) Assignee: TOSHIBA TEC KABUSHIKI KAISHA, Tokyo (JP)

(21) Appl. No.: 17/339,135

(22) Filed: Jun. 4, 2021

(30) Foreign Application Priority Data
Sep. 4, 2020 (JP) 2020-149041
Apr. 6, 2021 (JP) 2021-064929

(51) Int. Cl. G03G 9/087

(52) U.S. Cl. CPC G03G 9/08755; G03G 9/08797; G03G 9/08782

(57) ABSTRACT

According to one embodiment, a toner has improved low-temperature fixability, has excellent low-temperature fixability even in a high-temperature and high-humidity environment, and can sufficiently maintain the charge amount. Also provided are a toner cartridge and an image forming apparatus, in each of which the toner is stored. A toner according to an embodiment comprises toner base particles. The toner base particles comprise a crystalline polyester resin component and an amorphous polyester resin component.

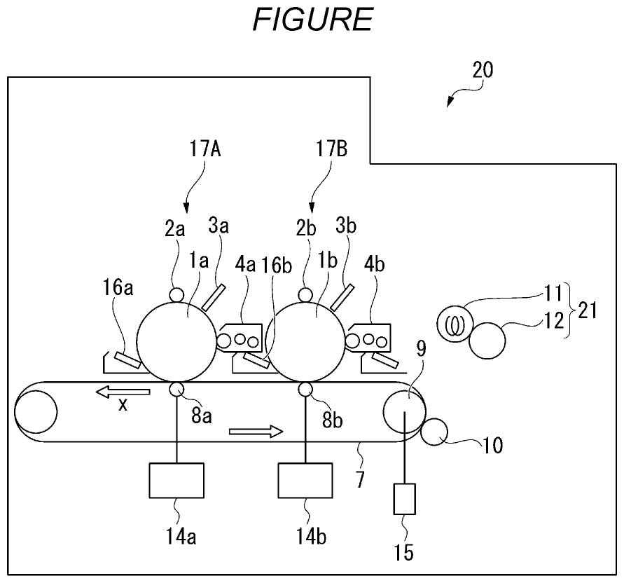

### CROSS-REFERENCE TO RELATED APPLICATION

This application is based upon and claims the benefit of priority from Japanese Patent Application No. 2020-149041, filed on Sep. 4, 2020 and JP application No. 2021-064929 filed on Apr. 6, 2021 the entire contents of which are incorporated herein by reference.

### FIELD

Embodiments described herein relate generally to a toner, a toner cartridge, and an image forming apparatus.

### BACKGROUND

There is known a toner containing a crystalline polyester resin (for example, Japanese Patent No. 3693327). The crystalline polyester resin has a low glass transition temperature, and therefore is used in a low-temperature fixable toner. The low-temperature fixable toner can be favorably applied to an image forming apparatus including a heating-type fixing device.

The low-temperature fixable toner is required to further improve the low-temperature fixability from the viewpoint of power saving or the like.

However, when the low-temperature fixable toner containing a crystalline polyester resin is left in a high-temperature and high-humidity environment, the glass transition temperature of the crystalline polyester resin in the toner rapidly increases. Therefore, the low-temperature fixability in a high-temperature and high-humidity environment decreases.

In addition, the crystalline polyester resin has high hygroscopicity, and therefore, in the low-temperature fixable toner containing a crystalline polyester resin, the charge amount of the toner is likely to decrease in a high-temperature and high-humidity environment.

From the above reasons, in the low-temperature fixable toner in the related art, excellent low-temperature fixability and chargeability in a high-temperature and high-humidity environment are not easily maintained.

### BRIEF DESCRIPTION OF THE DRAWING

The FIGURE is a diagram showing an example of a schematic structure of an image forming apparatus of an embodiment.

### DETAILED DESCRIPTION

An object to be achieved by embodiments is to provide a toner having excellent low-temperature fixability at normal temperature, and also having excellent low-temperature fixability and chargeability in a high-temperature and high-humidity environment; and a toner cartridge and an image forming apparatus, in each of which the toner is stored.

A toner according to an embodiment comprises toner base particles. The toner base particles comprise a crystalline polyester resin component and an amorphous polyester resin component. The amorphous polyester resin component comprises at least two or more types of multiple amorphous polyester resins.

The glass transition temperature of an amorphous polyester resin A, the content of which is highest in the multiple amorphous polyester resins, is 52° C. or lower.

The melting temperature of an amorphous polyester resin B which is at least one type of the multiple amorphous polyester resins other than the amorphous polyester resin A is 100° C. or higher.

The proportion of the amorphous polyester resin A is 80 mass % or more with respect to 100 mass % of the amorphous polyester resin component.

The proportion of the amorphous polyester resin B is 20 mass % or less with respect to 100 mass % of the amorphous polyester resin component.

The proportion of the crystalline polyester resin component is 10 mass % or less with respect to 100 mass % of the toner base particles.

First, the toner of the embodiment according to a first embodiment is described.

The toner of the embodiment comprises toner base particles. The toner of the embodiment may further comprise an external additive attached to the surfaces of the toner base particles.

The toner base particles is described.

The toner base particles comprise a crystalline polyester resin component and an amorphous polyester resin component. The toner base particles may further comprise a colorant and a release agent in addition to the crystalline polyester resin component and the amorphous polyester resin component.

The toner base particles may further comprise another component other than the crystalline polyester resin component, the amorphous polyester resin component, the colorant, and the release agent as long as the effect disclosed in the embodiment is obtained.

In the embodiment, a polyester resin in which the ratio of the softening temperature to the melting temperature (softening temperature/melting temperature) is less than 0.8 or more than 1.2 is defined as an “amorphous polyester resin”. Further, a polyester resin in which the ratio of the softening temperature to the melting temperature (softening temperature/melting temperature) is between 0.8 and 1.2 is defined as a “crystalline polyester resin”.

The amorphous polyester resin component is described.

The amorphous polyester resin component comprises at least two or more types of multiple amorphous polyester resins. An amorphous polyester resin, the content of which is highest in the multiple amorphous polyester resins, is an amorphous polyester resin A. The glass transition temperature of the amorphous polyester resin A is 52° C. or lower.

Then, a resin having a melting temperature of 100° C. or higher in the multiple amorphous polyester resins is an amorphous polyester resin B. The amorphous polyester resin B is at least one or more types of resins other than the amorphous polyester resin A.

The amorphous polyester resin A is described.

The glass transition temperature of the amorphous polyester resin A is 52° C. or lower. Therefore, the toner of the embodiment has excellent low-temperature fixability, and also has excellent low-temperature fixability in a high-temperature and high-humidity environment. In the toner of the embodiment, by setting the glass transition temperature of the amorphous polyester resin A to 52° C. or lower, the toner has excellent offset resistance at low temperature. As a result, the low-temperature fixability can be further improved as compared with the low-temperature fixable toner in the related art.

The glass transition temperature of the amorphous polyester resin A is preferably between 42 and 52° C., more preferably between 45 and 52° C., and further more preferably between 47 and 50° C. When the glass transition temperature of the amorphous polyester resin A is the lower limit of the above-mentioned numerical value range or higher, the toner is less likely to adhere to a roller when fixing. Therefore, the toner has excellent offset resistance.

The glass transition temperature of the amorphous polyester resin A can be measured by, for example, a differential scanning calorimeter (DSC).

The mass average molecular weight of the amorphous polyester resin A is preferably between 5×10³ and 9×10³, more preferably between 5×10³ and 8×10³, and further more preferably between 6×10³ and 8×10³. When the mass average molecular weight of the amorphous polyester resin A is within the above-mentioned range, the glass transition temperature of the amorphous polyester resin A tends to be at 52° C. or lower.

Further, when the mass average molecular weight of the amorphous polyester resin A is the above lower limit or more, the viscosity of the toner when fixing becomes higher, and the toner has more excellent low-temperature fixability. When the mass average molecular weight of the amorphous polyester resin A is the above upper limit or less, the viscosity of the toner when fixing becomes lower. Therefore, the toner is less likely to adhere to a roller when fixing, and has excellent offset resistance.

The mass average molecular weight of the amorphous polyester resin A is a value in terms of polyethylene glycol measured by gel permeation chromatography.

As the amorphous polyester resin A, for example, a condensation polymer of a divalent or higher valent carboxylic acid and a dihydric or higher hydric alcohol is exemplified.

Examples of the divalent or higher valent carboxylic acid include a divalent or higher valent carboxylic acid, an acid anhydride of a divalent or higher valent carboxylic acid, and an ester of a divalent or higher valent carboxylic acid. Examples of the ester of a divalent or higher valent carboxylic acid include a lower alkyl (having 1 to 12 carbon atoms) ester of a divalent or higher valent carboxylic acid.

Examples of the divalent carboxylic acid include maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, and succinic acid substituted with an alkyl group or an alkenyl group. However, the divalent carboxylic acid is not limited to these examples.

Examples of the succinic acid substituted with an alkyl group or an alkenyl group include succinic acid substituted with an alkyl group or an alkenyl group having 2 to 20 carbon atoms. For example, n-dodecenyl succinic acid, n-dodecyl succinic acid, and the like are exemplified. Further, an acid anhydride of the above-mentioned divalent carboxylic acid, or an ester of the above-mentioned divalent carboxylic acid may be used.

As the divalent carboxylic acid, maleic acid, fumaric acid, terephthalic acid, or succinic acid substituted with an alkenyl group having 2 to 20 carbon atoms is preferred.

As the divalent carboxylic acid, any one type may be used by itself or two or more types may be used in combination.

Examples of the trivalent or higher valent carboxylic acid include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, enpol trimer acid, acid anhydrides thereof or esters thereof. However, the trivalent or higher valent carboxylic acid is not limited to these examples,

As the trivalent or higher valent carboxylic acid, 1,2,4-benzenetricarboxylic acid (trimellitic acid), an acid anhydride thereof, or a lower alkyl (having 1 to 12 carbon atoms) ester thereof is preferred.

As the trivalent or higher valent carboxylic acid, any one type may be used by itself or two or more types may be used in combination.

Examples of the dihydric alcohol include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, hydrogenated bisphenol A, and an alkylene oxide adduct of bisphenol A. However, the dihydric alcohol is not limited to these examples.

As the alkylene oxide adduct of bisphenol A, a compound obtained by adding 1 to 10 moles on the average of an alkylene oxide having 2 to 3 carbon atoms to bisphenol A is exemplified. Examples of the alkylene oxide adduct of bisphenol A include polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane, and polyoxypropylene (6)-2,2-bis(4-hydroxyphenyl)propane.

As the dihydric alcohol, an alkylene oxide adduct of bisphenol A is preferred. As the dihydric alcohol, any one type may be used by itself or two or more types may be used in combination.

Examples of the trihydric or higher hydric alcohol include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. However, the trihydric or higher hydric alcohol is not limited to these examples.

As the trihydric or higher hydric alcohol, sorbitol, 1,4-sorbitan, pentaerythritol, glycerol, or trimethylolpropane is preferred.

As the trihydric or higher hydric alcohol, any one type may be used by itself or two or more types may be used in combination.

The carboxylic acid and the alcohol are selected from these divalent or higher valent carboxylic acids and dihydric or higher hydric alcohols so that the glass transition temperature of the amorphous polyester resin A is at 52° C. or lower.

The melting temperature and the mass average molecular weight of the amorphous polyester resin A can be adjusted by, for example, selecting the types of the divalent or higher valent carboxylic acid and the dihydric or higher hydric alcohol, and the composition thereof or changing the polymerization time.

When the dihydric or higher hydric alcohol and the divalent or higher valent carboxylic acid are subjected to polycondensation, a commonly used catalyst may be used for accelerating the reaction. Examples of the catalyst include dibutyltin oxide, a titanium compound, dialkoxy tin(II), tin(II) oxide, fatty acid tin(II), tin(II) dioctanoate, and tin(II) distearate.

The amorphous polyester resin B is described.

The melting temperature of the amorphous polyester resin B is 100° C. or higher. Therefore, the toner of the embodiment is less likely to adhere to a roller when fixing, and has excellent offset resistance at high temperature. In addition, the toner also has excellent storage stability.

The melting temperature of the amorphous polyester resin B is preferably between 100° C. and 160° C., more preferably between 120° C. and 160° C., further more preferably between 120° C. and 150° C., and particularly preferably between 130° C. and 150° C. When the melting temperature of the amorphous polyester resin B is the upper limit of the above-mentioned numerical value range or lower, the toner has more excellent low-temperature fixability.

The melting temperature of the amorphous polyester resin B can be measured by, for example, a constant test force extrusion type capillary rheometer (flow tester).

The mass average molecular weight of the amorphous polyester resin B is preferably between 1×10⁴ and 9×10⁴, more preferably between 2×10⁴ and 7×10⁴, and further more preferably between 2×10⁴ and 6×10⁴. When the mass average molecular weight of the amorphous polyester resin B is within the above-mentioned range, the melting temperature of the amorphous polyester resin B tends to be at 100° C. or higher.

Further, when the mass average molecular weight of the amorphous polyester resin B is the above lower limit or more, the viscosity of the toner when fixing becomes higher, and the toner has more excellent low-temperature fixability. When the mass average molecular weight of the amorphous polyester resin B is the above upper limit or less, the viscosity of the toner when fixing becomes lower, and offset is less likely to occur.

The mass average molecular weight of the amorphous polyester resin B is a value in terms of polyethylene glycol measured by gel permeation chromatography.

As the amorphous polyester resin B, for example, a condensation polymer of a divalent or higher valent carboxylic acid and a dihydric or higher hydric alcohol is exemplified.

Examples of the divalent or higher valent carboxylic acid and the dihydric or higher hydric alcohol include the same ones as described with respect to the amorphous polyester resin A. The carboxylic acid and the alcohol are selected from these divalent or higher valent carboxylic acids and dihydric or higher hydric alcohols so that the melting temperature becomes 100° C. or higher.

The melting temperature and the mass average molecular weight of the amorphous polyester resin B can be adjusted by, for example, selecting the types of the divalent or higher valent carboxylic acid and the dihydric or higher hydric alcohol, and the composition thereof or changing the polymerization time.

The amorphous polyester resin component can further comprise another amorphous polyester resin other than the amorphous polyester resin A and the amorphous polyester resin B.

For the another amorphous polyester resin, for example, an amorphous polyester resin having a glass transition temperature higher than 52° C., and an amorphous polyester resin having a melting temperature lower than 100° C. is exemplified.

For the another amorphous polyester resin, one type may be contained in the amorphous polyester resin component by itself, or two or more types may be contained in the amorphous polyester resin component.

The proportion of the amorphous polyester resin A is 80 mass % or more with respect to 100 mass % of the amorphous polyester resin component. Therefore, the toner of the embodiment has excellent low-temperature fixability at normal temperature.

In the first embodiment, the proportion of the amorphous polyester resin A is preferably between 80 and 90 mass %, and more preferably between 80 and 85 mass % with respect to 100 mass % of the amorphous polyester resin component. When the proportion of the amorphous polyester resin A is the upper limit of the above-mentioned numerical value range or less, the toner has excellent storage stability.

The proportion of the amorphous polyester resin B is 20 mass % or less with respect to 100 mass % of the amorphous polyester resin component. Therefore, the toner of the embodiment has excellent low-temperature fixability at normal temperature.

In the first embodiment, the proportion of the amorphous polyester resin B is preferably between 10 and 20 mass %, and more preferably between 15 and 20 mass % with respect to 100 mass % of the amorphous polyester resin component. When the proportion of the amorphous polyester resin B is the lower limit of the above-mentioned numerical value range or more, the toner has excellent storage stability.

In the toner of the embodiment, the proportion of the amorphous polyester resin A is 80 mass % or more and the proportion of the amorphous polyester resin B is 20 mass % or less with respect to 100 mass % of the amorphous polyester resin component. Since the proportion of each of the amorphous polyester resin A and the amorphous polyester resin B is within this range, the toner has excellent offset resistance at low temperature and excellent offset resistance at high temperature. As a result, a fixing temperature width in which offset hardly occurs, that is, an offset width is ensured. Further, the toner of the embodiment also has excellent storage stability.

When the amorphous polyester resin component contains other amorphous polyester resins, the total proportion of the other amorphous polyester resins is preferably between 5 and 20 mass %, and more preferably between 10 and 15 mass % with respect to 100 mass % of the amorphous polyester resin component from the viewpoint of low-temperature fixability.

The crystalline polyester resin component is described.

The crystalline polyester resin component may comprise one type of crystalline polyester resin by itself or may comprise two or more types of crystalline polyester resins.

The melting point of the crystalline polyester resin is preferably between 60 and 120° C., more preferably between 70 and 115° C., and further more preferably between 80 and 110° C. When the melting point of the crystalline polyester resin is the above lower limit or higher, the toner has excellent storage stability. When the melting point of the crystalline polyester resin is the above upper limit or lower, the toner has more excellent low-temperature fixability.

The melting point of the crystalline polyester resin can be measured as, for example, a maximum endothermic peak temperature by a differential scanning calorimeter (DSC).

The mass average molecular weight of the crystalline polyester resin is preferably between 6.0×10³ and 1.8×10⁴, and more preferably between 8.0×10³ and 1.4×10⁴. When the mass average molecular weight of the crystalline polyester resin is the above lower limit or more, the viscosity of the toner when fixing becomes higher, and the low-temperature fixability is further improved. When the mass average molecular weight of the crystalline polyester resin is the above upper limit or less, the viscosity of the toner when fixing becomes lower, and offset is less likely to occur.

The mass average molecular weight of the crystalline polyester resin is a value in terms of polystyrene measured by gel permeation chromatography.

As the crystalline polyester resin, for example, a condensation polymer of a dihydric or higher hydric alcohol and a divalent or higher valent carboxylic acid is exemplified.

Examples of the dihydric or higher hydric alcohol include ethylene glycol, 1,2-propylene glycol, 1,3-propylene glycol, 1,4-butanediol, 1,5-pentanediol, 1,6-hexanediol, neopentyl glycol, 1,4-butenediol, polyoxypropylene, polyoxyethylene, glycerin, pentaerythritol, and trimethylolpropane. However, the dihydric or higher hydric alcohol is not limited to these examples.

As the dihydric or higher hydric alcohol, 1,4-butanediol or 1,6-hexanediol is preferred.

As the dihydric or higher hydric alcohol, any one type may be used by itself or two or more types may be used in combination.

Examples of the divalent or higher valent carboxylic acid include adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, succinic acid substituted with an alkyl group or an alkenyl group, cyclohexane dicarboxylic acid, trimellitic acid, pyromellitic acid, and acid anhydrides thereof or esters thereof. However, the divalent or higher valent carboxylic acid is not limited to these examples.

Examples of the succinic acid substituted with an alkyl group or an alkenyl group include succinic acid substituted with an alkyl group or an alkenyl group having 2 to 20 carbon atoms. For example, n-dodecenyl succinic acid, n-dodecyl succinic acid, and the like are exemplified.

For the divalent or higher valent carboxylic acid, fumaric acid is preferred.

For the divalent or higher valent carboxylic acid, any one type may be used by itself or two or more types may be used in combination.

However, the crystalline polyester resin is not limited to the condensation polymer of a dihydric or higher hydric alcohol and a divalent or higher valent carboxylic acid exemplified here. As the crystalline polyester resin, any one type may be used by itself or two or more types may be used in combination.

Another binder resin is described.

As another binder resin, for example, a styrenic resin, an ethylenic resin, an acrylic resin, a phenolic resin, an epoxy-based resin, an allyl phthalate-based resin, a polyamide-based resin, or a maleic acid-based resin is exemplified. However, the another binder resin is not limited to these examples.

As the another binder resin, any one type may be used by itself or two or more types may be used in combination.

A styrenic resin, an ethylenic resin, an acrylic resin, a phenolic resin, an epoxy-based resin, an allyl phthalate-based resin, a polyamide-based resin, or a maleic acid-based resin is obtained by, for example, polymerizing a vinyl polymerizable monomer by itself or multiple types of vinyl polymerizable monomers.

Examples of the vinyl polymerizable monomer include an aromatic vinyl monomer, an ester-based monomer, a carboxylic acid-containing monomer, and an amine-based monomer.

Examples of the aromatic vinyl monomer include styrene, methylstyrene, methoxystyrene, phenylstyrene, chlorostyrene, and derivatives thereof.

Examples of the ester-based monomer include methyl acrylate, ethyl acrylate, butyl acrylate, methyl methacrylate, ethyl methacrylate, butyl methacrylate, and derivatives thereof.

Examples of the carboxylic acid-containing monomer include acrylic acid, methacrylic acid, fumaric acid, maleic acid, and derivatives thereof.

Examples of the amine-based monomer include amino acrylate, acrylamide, methacrylamide, vinylpyridine, vinylpyrrolidone, and derivatives thereof.

The another binder resin may be obtained by polycondensation of a polymerizable monomer component composed of an alcohol component and a carboxylic acid component. In the polycondensation of the polymerizable monomer component, various auxiliary agents such as a chain transfer agent, a crosslinking agent, a polymerization initiator, a surfactant, an aggregating agent, a pH adjusting agent, and an anti-foaming agent may be used.

The release agent is described.

When the toner base particles comprise the release agent, the toner is much less likely to adhere to a roller when fixing, and therefore, the toner has more excellent offset resistance.

Examples of the release agent include aliphatic hydrocarbon-based waxes such as low-molecular weight polyethylenes, low-molecular weight polypropylenes, polyolefin copolymers, polyolefin waxes, paraffin waxes, and Fischer-Tropsch waxes, and modified products thereof; vegetable waxes such as candelilla wax, carnauba wax, Japan wax, jojoba wax, and rice wax; animal waxes such as beeswax, lanolin, and spermaceti wax; mineral waxes, such as montan wax, ozokerite, and ceresin; ester waxes; fatty acid amides such as linoleic acid amide, oleic acid amide, and lauric acid amide; functional synthetic waxes; and silicone-based waxes.

As the release agent, any one type may be used by itself, or two or more types may be used in combination.

Among these, as for the release agent, an ester wax is preferred, and from the viewpoint of the heat resistance and storage stability of the toner, the following specific ester wax α is preferred. The ester wax a is composed of two or more types of ester compounds having different carbon numbers.

ester wax α: a condensation polymer of a first monomer group composed of at least three or more types of carboxylic acids and a second monomer group composed of at least two or more types of alcohols

With respect to the ester wax α, the first monomer group is described.

The number of types of carboxylic acids in the first monomer group is preferably 7 types or less, more preferably 5 types or less, and further more preferably 4 types or less from the viewpoint that the ester wax α is easy to obtain.

Here, the carbon number of a carboxylic acid, the content of which is highest in the first monomer group, is denoted by Cₙ. The carbon number Cₙ is preferably between 19 and 28, more preferably between 19 and 24, and further more preferably between 20 and 24. When the carbon number Cₙ is the above lower limit or more, the heat resistance of the ester wax α is improved. When the carbon number Cₙ is the above upper limit or less, the toner has more excellent low-temperature fixability.

The proportion of the carboxylic acid with a carbon number of Cₙ, the content of which is highest, is preferably between 70 and 95 mass %, more preferably between 80 and 95 mass %, and furthermore preferably between 85 and 95 mass % with respect to 100 mass % of the first monomer group. When the proportion of the carboxylic acid with a carbon number of Cₙ is the above lower limit or more, the maximum peak of the carbon number distribution of the ester wax a is easily located on the high carbon number side. Therefore, the toner has excellent heat resistance and storage stability. When the proportion of the carboxylic acid with a carbon number of Cₙ is the above upper limit or less, the ester wax α is easy to obtain.

The proportion of a carboxylic acid with a carbon number of 18 or less in the first monomer group is preferably between 0 and 5 mass %, and more preferably between 0 and 1 mass % with respect to 100 mass % of the first monomer group. When the proportion of the carboxylic acid with a carbon number of 18 or less is the above lower limit or more, the ester wax α is easy to obtain. When the proportion of the carboxylic acid with a carbon number of 18 or less is the above upper limit or less, the proportion of an ester compound having a relatively low molecular weight in the ester wax α becomes smaller. As a result, the toner has excellent heat resistance and storage stability.

The content of each of the carboxylic acids with the corresponding carbon number in the first monomer group can be measured by, for example, mass spectrometry using FD-MS (field desorption mass spectrometry) for a product after a methanolysis reaction of the ester wax α.

As the carboxylic acid in the first monomer group, a long-chain carboxylic acid is preferred from the viewpoint that the ester wax α is easy to obtain, and a long-chain alkyl carboxylic acid is more preferred. The long-chain carboxylic acid is appropriately selected according to the property, performance, and the like required for the ester wax α.

The long-chain carboxylic acid is preferably a long-chain carboxylic acid with a carbon number of 19 to 28, and more preferably a long-chain carboxylic acid with a carbon number of 20 to 24. When the carbon number of the long-chain carboxylic acid is the above lower limit or more, the heat resistance of the ester wax α is improved. When the carbon number of the long-chain carboxylic acid is the above upper limit or less, the toner has more excellent low-temperature fixability.

Examples of the long-chain alkyl carboxylic acid include palmitic acid, stearic acid, arachidonic acid, behenic acid, lignoceric acid, cerotic acid, and montanic acid.

With respect to the ester wax α, the second monomer group is described.

The number of types of alcohols in the second monomer group is preferably 5 types or less, more preferably 4 types or less, and further more preferably 3 types or less from the viewpoint that the ester wax α is easy to obtain.

Here, the carbon number of an alcohol, the content of which is highest in the second monomer group, is denoted by Cₘ. The carbon number Cₘ is preferably between 19 and 28, more preferably between 20 and 24, and further more preferably between 20 and 22. When the carbon number Cₘ is the above lower limit or more, the heat resistance of the ester wax α is improved. When the carbon number Cₘ is the above upper limit or less, the toner has more excellent low-temperature fixability.

The proportion of the alcohol with a carbon number of Cₘ, the content of which is highest, is preferably between 70 and 90 mass %, more preferably between 80 and 90 mass %, and further more preferably between 85 and 90 mass % with respect to 100 mass % of the second monomer group. When the proportion of the alcohol with a carbon number of Cₘ is the above lower limit or more, the maximum peak of the carbon number distribution of the ester wax α is easily located on the high carbon number side. Therefore, the toner has excellent heat resistance and storage stability. When the proportion of the alcohol with a carbon number of Cₘ is the above upper limit or less, the ester wax α is easy to obtain.

The proportion of an alcohol with a carbon number of 18 or less in the second monomer group is preferably 20 mass % or less, more preferably between 10 and 20 mass %, and further more preferably between 15 and 20 mass % with respect to 100 mass % of the second monomer group. When the proportion of the alcohol with a carbon number of 18 or less is the above lower limit or more, the ester wax α is easy to obtain. When the proportion of the alcohol with a carbon number of 18 or less is the above upper limit or less, the proportion of an ester compound having a relatively low molecular weight in the ester wax α becomes smaller. Therefore, the toner has excellent heat resistance and storage stability.

The content of each of the alcohols with the corresponding carbon number in the second monomer group can be measured by, for example, mass spectrometry using FD-MS for a product after a methanolysis reaction of the ester wax α.

As the alcohol in the second monomer group, a long-chain alcohol is preferred from the viewpoint that the ester wax α is easy to obtain, and a long-chain alkyl alcohol is more preferred. The long-chain alcohol is appropriately selected according to the property, performance, and the like required for the ester wax α.

The long-chain alcohol is preferably a long-chain alcohol with a carbon number of 19 to 28, and more preferably a long-chain alcohol with a carbon number of 20 to 22. When the carbon number of the long-chain alcohol is the above lower limit or more, the heat resistance of the ester wax α is improved. When the carbon number of the long-chain alcohol is the above upper limit or less, the toner has more excellent low-temperature fixability.

Examples of the long-chain alkyl alcohol include palmityl alcohol, stearyl alcohol, arachidyl alcohol, behenyl alcohol, lignoceryl alcohol, ceryl alcohol, and montanyl alcohol.

In the ester wax α, an ester compound with a carbon number of C₁, the content of which is highest among the ester compounds constituting the ester wax α, is preferably present. The carbon number C₁ is preferably 43 or more, more preferably between 43 and 56, further more preferably between 43 and 52, particularly preferably between 44 and 46, and most preferably 44. When the carbon number C₁ is the above lower limit or more, the toner has excellent heat resistance and storage stability. When the carbon number C₁ is the above upper limit or less, the ester wax α is easy to obtain.

The ester compound with a carbon number of C₁ is represented by the following formula (I).

R¹COOR² (I)

In the formula (I), R¹ and R² are each an alkyl group. The total carbon number of R¹ and R² is preferably 42 or more, more preferably between 42 and 55, further more preferably between 42 and 51, particularly preferably between 43 and 45, and most preferably 43. When the total carbon number of R¹ and R² is the above lower limit or more, the toner has excellent heat resistance and storage stability. When the total carbon number of R¹ and R² is the above upper limit or less, the ester wax α is easy to obtain. The carbon number of R¹ can be controlled by, for example, adjusting the carbon number Cₙ of the carboxylic acid with a carbon number of Cₙ. The carbon number of R² can be controlled by, for example, adjusting the carbon number Cₘ of the alcohol with a carbon number of Cₘ.

The proportion of the ester compound with a carbon number of C₁ is preferably 65 mass % or more, more preferably between 65 and 90 mass %, further more preferably between 70 and 90 mass %, and particularly preferably between 80 and 90 mass % with respect to 100 mass % of the ester wax α. When the proportion of the ester compound with a carbon number of C₁ is the above lower limit or more, the maximum peak of the carbon number distribution of the ester wax α becomes sufficiently higher. As a result, the toner has excellent heat resistance and storage stability.

When the proportion of the ester compound with a carbon number of C₁ is the above upper limit or less, the ester wax α is easy to obtain.

The carbon number distribution of the ester wax α preferably has only one maximum peak in a region where the carbon number is 43 or more. In that case, the proportion of an ester compound having a relatively low molecular weight becomes smaller. As a result, the toner has excellent heat resistance and storage stability.

In the carbon number distribution of the ester wax α, the position of the maximum peak is preferably in a region where the carbon number is between 43 and 56, more preferably in a region where the carbon number is between 44 and 52, further more preferably in a region where the carbon number is between 44 and 46, and most preferably a position where the carbon number is 44. When the position of the maximum peak is in a region where the carbon number is the above lower limit or more, the toner has more excellent heat resistance and storage stability. When the position of the maximum peak is in a region where the carbon number is the above upper limit or less, the ester wax α is easy to obtain.

The content of each of the ester compounds with the corresponding carbon number in the ester wax α can be measured by, for example, mass spectrometry using FD-MS.

The melting point of the ester wax α is preferably between 60 and 85° C., more preferably between 65 and 80° C., and further more preferably between 65 and 75° C. When the melting point of the ester wax α is the above lower limit or higher, the toner has excellent heat resistance and storage stability. Further, offset is less likely to occur in a high temperature environment. When the melting point of the ester wax α is the above upper limit or lower, the toner has more excellent low-temperature fixability.

The melting point of the ester wax α can be measured as, for example, a maximum endothermic peak temperature by differential scanning calorimetry (DSC).

The ester wax α can be synthesized by, for example, subjecting a long-chain carboxylic acid and a long-chain alcohol to an esterification reaction. In the esterification reaction, at least three or more types of long-chain alkyl carboxylic acids and at least two or more types of long-chain alkyl alcohols are preferably used. By adjusting the carbon number and the used amount of each of the long-chain alkyl carboxylic acids and the long-chain alkyl alcohols, the carbon number distribution of the ester compound contained in the ester wax α can be adjusted.

The esterification reaction can be performed while heating, for example, under a nitrogen gas stream. The esterification reaction product may be purified by being dissolved in a solvent containing ethanol, toluene, or the like, and further adding a basic aqueous solution such as a sodium hydroxide aqueous solution to separate the solution into an organic layer and an aqueous layer. By removing the aqueous layer, the ester wax α is obtained. The purification operation is preferably repeated a plurality of times.

The colorant is described.

The colorant is not particularly limited. Examples thereof include carbon black, cyan, yellow, and magenta-based pigments and dyes.

Examples of the carbon black include aniline black, lamp black, acetylene black, furnace black, thermal black, channel black, and Ketjen black.

Examples of the pigments and dyes include Fast Yellow G, benzidine yellow, chrome yellow, quinoline yellow, Indofast Orange, Irgazin Red, Carmine FB, Permanent Bordeaux FRR, Pigment Orange R, Lithol Red 2G, Lake Red C, Rhodamine FB, Rhodamine B Lake, Du Pont Oil Red, phthalocyanine blue, Pigment Blue, aniline blue, calcoil blue, ultramarine blue, brilliant green B, phthalocyanine green, malachite green oxalate, methylene blue chloride, rose bengal, and quinacridone.

Examples of the colorant include C.I. Pigment Black 1, 6, and 7, C.I. Pigment Yellow 1, 12, 14, 17, 34, 74, 83, 97, 155, 180, and 185, C.I. Pigment Orange 48 and 49, C.I. Pigment Red 5, 12, 31, 48, 48:1, 48:2, 48:3, 48:4, 48:5, 49, 53, 53:1, 53:2, 53:3, 57, 57:1, 81, 81:4, 122, 146, 150, 177, 185, 202, 206, 207, 209, 238, and 269, C.I. Pigment Blue 15, 15:1, 15:2, 15:3, 15:4, 15:5, 15:6, 75, 76, and 79, C.I. Pigment Green 1, 7, 8, 36, 42, and 58, C.I. Pigment Violet 1, 19, and 42, and C.I. Acid Red 52, each of which is indicated by the Color Index Number.

Another component is described.

As another component, an additive such as a charge control agent, a surfactant, a basic compound, an aggregating agent, a pH adjusting agent, or an antioxidant is exemplified. However, the additive is not limited to these examples. As the additive, any one type may be used by itself or two or more types may be used in combination.

The charge control agent is described.

When the toner base particles contain the charge control agent, the toner is easily transferred onto a recording medium such as a paper. Examples of the charge control agent include a metal-containing azo compound, a metal-containing salicylic acid derivative compound, a hydrophobized metal oxide, and a polysaccharide inclusion compound. As the metal-containing azo compound, a complex or a complex salt in which the metal is iron, cobalt, or chromium, or a mixture thereof is preferred. As the metal-containing salicylic acid derivative compound and the hydrophobized metal oxide, a complex or a complex salt in which the metal is zirconium, zinc, chromium, or boron, or a mixture thereof is preferred. As the polysaccharide inclusion compound, a polysaccharide inclusion compound containing aluminum (Al) and magnesium (Mg) is preferred.

The composition of the toner base particles is described.

The proportion of the crystalline polyester resin component is 10 mass % or less with respect to 100 mass % of the toner base particles. Therefore, the toner of the embodiment has excellent low-temperature fixability and chargeability in a high-temperature and high-humidity environment.

In the first embodiment, the proportion of the crystalline polyester resin is preferably between 5 and 10 mass %, and more preferably between 5 and 7 mass % with respect to 100 mass % of the toner base particles. When the proportion of the crystalline polyester resin component is the above lower limit or more, the toner has more excellent low-temperature fixability at normal temperature. When the proportion of the crystalline polyester resin component is the above upper limit or less, the toner has more excellent low-temperature fixability and chargeability in a high-temperature and high-humidity environment.

The proportion of the amorphous polyester resin component is preferably between 70 and 90 mass %, more preferably between 70 and 85 mass %, and furthermore preferably between 70 and 80 mass % with respect to 100 mass % of the toner base particles. When the proportion of the amorphous polyester resin component is the above lower limit or more, the toner has more excellent low-temperature fixability and chargeability in a high-temperature and high-humidity environment. When the proportion of the amorphous polyester resin component is the above upper limit or less, the toner has more excellent low-temperature fixability at normal temperature.

When the toner base particles comprise the release agent, the proportion of the release agent is preferably between 3 and 15 mass %, more preferably between 3 and 13 mass %, and further more preferably between 5 and 10 mass % with respect to 100 mass % of the toner base particles. When the proportion of the release agent is the above lower limit or more, the toner has more excellent offset resistance. When the proportion of the release agent is the above upper limit or less, the charge amount is easily sufficiently maintained.

When the toner base particles comprise the colorant, the content of the colorant is preferably between 2 and 13 mass %, and more preferably between 3 and 8 mass % with respect to 100 mass % of the toner base particles. When the content of the colorant is the above lower limit or more, the toner has excellent color reproducibility. Further, when the content of the colorant is the above upper limit or less, the dispersibility of the colorant is improved and the toner has more excellent low-temperature fixability. In addition, the charge amount of the toner is easily controlled.

The external additive is described.

As the external additive, particles composed of an inorganic oxide are exemplified. The particles composed of an inorganic oxide may be subjected to a surface treatment with a hydrophobizing agent from the viewpoint of improving the stability.

Examples of the inorganic oxide include silica, titania, alumina, strontium titanate, titanium oxide, and tin oxide.

As the external additive, any one type may be used by itself or two or more types may be used in combination.

The external additive preferably contains silica particles from the viewpoint of the charge amount of the toner. Further, the external additive preferably contains at least one type selected from the group consisting of strontium titanate and titanium oxide from the viewpoint of a toner scattering amount.

As the silica particles, wet silica is preferred, and hydrophobic silica is more preferred.

The wet silica can be produced by, for example, a method (liquid phase method) in which sodium silicate made from silica sand is used as a raw material, and an aqueous solution containing sodium silicate is neutralized to deposit silica, and the silica is filtered and dried. On the other hand, fumed silica (dry silica) obtained by reacting silicon tetrachloride in a flame at high temperature is known. When wet silica is used as the external additive of the toner, the charge amount of the toner is generally easily maintained as compared with fumed silica having a low moisture content.

The hydrophobic silica particles are obtained by, for example, hydrophobizing a surface silanol group of wet silica with silane, silicone, or the like. When the hydrophobic silica particles are used as the external additive of the toner, the adhesiveness thereof to the toner base particles is enhanced.

The degree of hydrophobization of the hydrophobic silica can be measured by, for example, the following method.

50 mL of ion exchanged water and 0.2 g of a sample are placed in a beaker, and methanol is added dropwise thereto from a burette while stirring using a magnetic stirrer. Then, a powder gradually precipitates as the concentration of methanol in the beaker increases, and the volume percent of methanol in the mixed solution of methanol and ion exchanged water at the end point when the total amount thereof precipitated is defined as the degree of hydrophobization (%).

The particle diameter of the silica particle is preferably between 30 and 300 nm, more preferably between 30 and 200 nm, and further more preferably between 30 and 150 nm from the viewpoint of the charge amount of the toner. The particle diameter of the silica particle can be measured using, for example, a laser diffraction particle size distribution analyzer.

When the toner contains the external additive, the content of the external additive is preferably between 2 and 15 parts by mass, more preferably between 4 and 10 parts by mass, and further more preferably between 4 and 8 parts by mass with respect to 100 parts by mass of the toner base particles. When the content of the external additive is the above lower limit or more, the charge amount of the toner is easily sufficiently ensured. When the content of the external additive is the above upper limit or less, the charge amount of the toner is less likely to be excessively high. Therefore, the charge amount of the toner is easily moderately maintained.

A method for producing a toner is described.

The toner base particles can be produced by, for example, a kneading and pulverization method or a chemical method. The toner base particles can be directly used as the toner. When the toner including the external additive is produced, the toner base particles and the external additive are mixed.

The kneading and pulverization method is descried.

As the kneading and pulverization method, for example, a production method including the following mixing step, kneading step, and pulverization step is exemplified. The kneading and pulverization method may further include the following classification step as needed.
Mixing step: a step of mixing at least the amorphous polyester resin A, the amorphous polyester resin B, and the crystalline polyester resin, thereby obtaining a mixture
Kneading step: a step of melt-kneading the mixture, thereby obtaining a kneaded material
Pulverization step: a step of pulverizing the kneaded material, thereby obtaining a pulverized material
Classification step: a step of classifying the pulverized material

In the mixing step, the raw materials of the toner are mixed, thereby obtaining a mixture. In the mixing step, a mixer may be used. The mixer is not particularly limited. In the mixing step, a release agent, a colorant, another binder resin, or an additive may be used as needed.

In the kneading step, the mixture obtained in the mixing step is melt-kneaded, thereby obtaining a kneaded material. In the kneading step, a kneader may be used. The kneader is not particularly limited.

In the pulverization step, the kneaded material obtained in the kneading step is pulverized, thereby obtaining a pulverized material. In the pulverization step, a pulverizer may be used. As the pulverizer, various pulverizers such as a hammer mill can be used. Further, the pulverized material obtained by the pulverizer may be further finely pulverized. As a pulverizer that further finely pulverizes the pulverized material, various pulverizers can be used. The pulverized material obtained in the pulverization step may be directly used as the toner base particles, or may be subjected to the classification step as needed and used as the toner base particles.

In the classification step, the pulverized material obtained in the pulverization step is classified. In the classification step, a classifier may be used. The classifier is not particularly limited.

The chemical method is described.

In the chemical method, the amorphous polyester resin A, the amorphous polyester resin B, the crystalline polyester resin, and according to need, a release agent, a colorant, another binder resin, or an additive are mixed, thereby obtaining a mixture. Subsequently, the mixture is melt-kneaded, thereby obtaining a kneaded material. Subsequently, the kneaded material is pulverized, thereby obtaining coarsely granulated moderately pulverized particles. Subsequently, the moderately pulverized particles are mixed with an aqueous medium, thereby preparing a mixed liquid. Subsequently, the mixed liquid is subjected to mechanical shearing, thereby obtaining a fine particle dispersion liquid. Finally, fine particles are aggregated in the fine particle dispersion liquid, thereby forming toner base particles.

A method for mixing the external additive is described.

The external additive is mixed with the toner base particles using, for example, a mixer. The mixer is not particularly limited. By mixing the external additive with the toner base particles, the external additive is attached to surfaces of the toner base particles.

The external additive may be sieved using a sieving device as needed. The sieving device is not particularly limited. Various sieving devices can be used.

The toner of at least one embodiment according to the first embodiment described above not only has further improved low-temperature fixability, but also has excellent low-temperature fixability even in a high-temperature and high-humidity environment, and can sufficiently maintain the charge amount. In addition, the toner of the embodiment is less likely to adhere to a roller when fixing, and also has excellent offset resistance.

Next, the toner of the embodiment according to a second embodiment is described.

The toner of the embodiment according to the second embodiment is different from the toner of the embodiment according to the first embodiment mainly in the following point.
The proportion of the crystalline polyester resin component is 5 mass % or less with respect to 100 mass % of the toner base particles.

In the toner of the embodiment according to the second embodiment, the proportion of the crystalline polyester resin component is 5 mass % or less with respect to 100 mass % of the toner base particles. Therefore, the toner has more excellent chargeability in a high-temperature and high-humidity environment than the first embodiment.

Further, from the viewpoint of reducing the used amount of the crystalline polyester resin that is generally expensive, the toner of the embodiment according to the second embodiment can be inexpensively provided. Therefore, the toner of the embodiment according to the second embodiment is also advantageous in terms of cost.

The low-temperature fixability in the second embodiment is not as excellent as in the first embodiment, but the toner has excellent low-temperature fixability comparable to that of the low-temperature fixable toner in the related art. More excellent low-temperature fixability than that of the low-temperature fixable toner in the related art can also be achieved.

The storage stability in the second embodiment is not as excellent as in the first embodiment, but excellent storage stability sufficient for practical use can be achieved.

In the toner of the embodiment according to the second embodiment, not only the proportion of the crystalline polyester resin component, but also the proportion of each of the amorphous polyester resin A and the amorphous polyester resin B is different.

Hereinafter, the proportion of each of the crystalline polyester resin component, the amorphous polyester resin A, and the amorphous polyester resin B in the second embodiment is described.

In the second embodiment, the proportion of the amorphous polyester resin A is preferably between 90 and 95 mass % with respect to 100 mass % of the amorphous polyester resin component. When the proportion of the amorphous polyester resin A is the lower limit of the above-mentioned numerical value range or more, the toner has excellent low-temperature fixability at normal temperature. When the proportion of the amorphous polyester resin A is the upper limit of the above-mentioned numerical value range or less, the toner has excellent storage stability.

In the second embodiment, the proportion of the amorphous polyester resin B is preferably between 5 and 10 mass % with respect to 100 mass % of the amorphous polyester resin component. When the proportion of the amorphous polyester resin B is the lower limit of the above-mentioned numerical value range or more, the toner has excellent storage stability. When the proportion of the amorphous polyester resin B is the upper limit of the above-mentioned numerical value range or less, the toner has excellent low-temperature fixability at normal temperature.

In the second embodiment, the melting temperature of the amorphous polyester resin B is preferably between 130° C. and 160° C., and more preferably between 130° C. and 150° C. When the melting temperature of the amorphous polyester resin B is the lower limit of the above-mentioned numerical value range or higher, the toner has excellent offset resistance at high temperature. In addition, the toner also has excellent storage stability. When the melting temperature of the amorphous polyester resin B is the upper limit of the above-mentioned numerical value range or lower, the toner has more excellent low-temperature fixability.

The configurations other than those described in detail in the second embodiment are contents common to the first embodiment and the second embodiment. Further, the toner of the embodiment according to the second embodiment can be produced in the same manner as the toner of the embodiment according to the first embodiment except that the composition of the toner base particles is different. Therefore, the description of these common contents is omitted in the second embodiment.

Hereinafter, a toner cartridge of an embodiment is described.

In the toner cartridge of the embodiment, the toner of the embodiment described above is stored. The toner of this embodiment may be either of the toner according to the first embodiment and the toner according to the second embodiment. For example, the toner cartridge includes a container, and the toner of the embodiment is stored in the container. The container is not particularly limited, and various containers that can be applied to an image forming apparatus can be used.

The toner of the embodiment may be used as a one-component developer or may be combined with a carrier and used as a two-component developer.

Hereinafter, an image forming apparatus of an embodiment is described with reference to the drawing.

The FIGURE is a diagram showing an example of a schematic structure of the image forming apparatus of the embodiment.

An image forming apparatus 20 of the embodiment has an apparatus body including an intermediate transfer belt 7, and a first image forming unit 17A and a second image forming unit 17B provided in this order on the intermediate transfer belt 7, and a fixing device 21 provided downstream thereof. Along the running direction X of the intermediate transfer belt 7, that is, along the progress direction of the image forming process, the first image forming unit 17A is provided downstream of the second image forming unit 17B. The fixing device 21 is provided downstream of the first image forming unit 17A.

The first image forming unit 17A includes a photoconductive drum 1a, a cleaning device 16a, a charging device 2a, a light exposure device 3a, a first developing device 4a, and a primary transfer roller 8a. The cleaning device 16a, the charging device 2a, the light exposure device 3a, and the first developing device 4a are provided in this order along the rotational direction of the photoconductive drum 1a. The primary transfer roller 8a is provided on the photoconductive drum 1a through the intermediate transfer belt 7 so as to face the photoconductive drum 1a. To the primary transfer roller 8a, a primary transfer power supply 14a is connected.

The second image forming unit 17B includes a photoconductive drum 1b, a cleaning device 16b, a charging device 2b, a light exposure device 3b, a second developing device 4b, and a primary transfer roller 8b. The cleaning device 16b, the charging device 2b, the light exposure device 3b, and the second developing device 4b are provided in this order along the rotational direction of the photoconductive drum 1b. The primary transfer roller 8b is provided on the photoconductive drum 1b through the intermediate transfer belt 7 so as to face the photoconductive drum 1b. To the primary transfer roller 8b, a primary transfer power supply 14b is connected.

In the first developing device 4a and in the second developing device 4b, the toner of the embodiment described above is stored. The toner of this embodiment may be either of the toner according to the first embodiment and the toner according to the second embodiment. In an image forming apparatus according to another embodiment, the toner may be supplied from a toner cartridge (not shown).

Downstream of the first image forming unit 17A, a secondary transfer roller 9 and a backup roller 10 are disposed so as to face each other through the intermediate transfer belt 7. To the secondary transfer roller 9, a secondary transfer power supply 15 is connected.

The fixing device 21 is provided downstream of the first image forming unit 17A. The fixing device 21 includes a heat roller 11 and a press roller 12 disposed so as to face each other. The fixing device 21 is a device for fixing the toner to a recording medium. A toner image is fixed to a paper by heating and pressing using the heat roller 11 and the press roller 12.

By the image forming apparatus 20, image formation is performed, for example, as follows.

First, by the charging device 2b, the photoconductive drum 1b is uniformly charged. Subsequently, by the light exposure device 3b, light exposure is performed, whereby an electrostatic latent image is formed. Subsequently, the electrostatic latent image is developed using the toner of the embodiment supplied from the developing device 4b, whereby a second toner image is obtained.

Subsequently, by the charging device 2a, the photoconductive drum 1a is uniformly charged. Subsequently, by the light exposure device 3a, light exposure is performed based on first image information (second toner image), whereby an electrostatic latent image is formed. Subsequently, the electrostatic latent image is developed using the toner of the embodiment supplied from the developing device 4a, whereby a first toner image is obtained.

The second toner image and the first toner image are transferred in this order onto the intermediate transfer belt 7 using the primary transfer rollers 8a and 8b.

An image in which the second toner image and the first toner image are stacked in this order on the intermediate transfer belt 7 is secondarily transferred onto a recording medium (not shown) through the secondary transfer roller 9 and the backup roller 10. In this manner, an image in which the first toner image and the second toner image are stacked in this order is formed on the recording medium.

The image forming apparatus shown in the FIGURE is configured to fix a toner image. However, the image forming apparatus of the embodiment is not limited to this configuration. An image forming apparatus according to another embodiment may be, for example, configured to use an inkjet system.

### Examples

Hereinafter, embodiments are more specifically described by showing Examples.

The glass transition temperature (Tg), the melting temperature (Tm), and the mass average molecular weight (Mw) of the amorphous polyester resins A used in the respective Examples are as follows.

Amorphous polyester resin A1 (Tg: 50° C., Tm: 98° C., Mw: 7×10³)

Amorphous polyester resin A2 (Tg: 48° C., Tm: 95° C., Mw: 6×10³)

Amorphous polyester resin A3 (Tg: 54° C., Tm: 105° C., Mw: 1×10⁴)

Amorphous polyester resin A4 (Tg: 41° C., Tm: 90° C., Mw: 5×10⁴)

The melting temperature (Tm), the glass transition temperature (Tg), and the mass average molecular weight (Mw) of the amorphous polyester resins B used in the respective Examples are as follows.

Amorphous polyester resin B1 (Tm: 135° C., Tg: 56° C., Mw: 4.5×10⁴)

Amorphous polyester resin B2 (Tm: 145° C., Tg: 57° C., Mw: 5×10⁴)

Amorphous polyester resin B3 (Tm: 120° C., Tg: 54° C., Mw: 3.5×10⁴)

Amorphous polyester resin B4 (Tm: 130° C., Tg: 55° C., Mw: 4×10⁴)

The glass transition temperature of a crystalline polyester resin C used in the respective Examples is 60° C. The melting temperature of the crystalline polyester resin C is 100° C. The mass average molecular weight (Mw) of the crystalline polyester resin C is 9.5×10³.

The release agents used in the respective Examples are as follows.

Release agent A: ester wax (melting point: 72° C.)
Release agent B: ester wax (melting point: 70° C.)

A toner of Example 1 was produced as follows.

First, the following raw materials of toner base particles were placed in a Henschel mixer (manufactured by Mitsui Mining Co., Ltd.) and mixed. Further, the mixture of the raw materials of the toner base particles was melt-kneaded using a twin-screw extruder. The resulting melt-kneaded material was cooled, and then, coarsely pulverized using a hammer mill. The coarsely pulverized material was finely pulverized using a jet pulverizer. The finely pulverized material was classified, whereby toner base particles were obtained. The volume average diameter of the toner base particles was 7 μm. The volume average diameter of the toner base particles was measured using a laser diffraction particle size distribution analyzer (manufactured by Shimadzu Corporation (SALD-7000)).

The composition of the raw materials of the toner base particles is shown below.

| | | |
|---|---|---|
| Amorphous polyester resin A1 | 64 | parts by mass |
| Amorphous polyester resin B1 | 16 | parts by mass |
| Crystalline polyester resin C | 10 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

Subsequently, with respect to 100 parts by mass of the toner base particles of Example 1, an external additive having the following composition was mixed using a Henschel mixer, whereby the toner of Example 1 was produced.

| | |
|---|---|
| Silica particles | 3.8 parts by mass |
| Titanium oxide | 0.5 parts by mass |

A toner of Example 2 was produced as follows.

First, toner base particles of Example 2 were produced in the same manner as in Example 1 except that the composition of the raw materials of the toner base particles was changed as follows. Subsequently, the toner base particles and an external additive were mixed in the same manner as in Example 1, whereby the toner of Example 2 was produced.

| | | |
|---|---|---|
| Amorphous polyester resin A2 | 64 | parts by mass |
| Amorphous polyester resin B2 | 16 | parts by mass |
| Crystalline polyester resin C | 10 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

A toner of Example 3 was produced as follows.

First, toner base particles of Example 3 were produced in the same manner as in Example 1 except that the composition of the raw materials of the toner base particles was changed as follows. Subsequently, the toner base particles and an external additive were mixed in the same manner as in Example 1, whereby the toner of Example 3 was produced.

| | | |
|---|---|---|
| Amorphous polyester resin A2 | 68 | parts by mass |
| Amorphous polyester resin B2 | 12 | parts by mass |
| Crystalline polyester resin C | 10 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

A toner of Example 4 was produced as follows.

First, toner base particles of Example 4 were produced in the same manner as in Example 1 except that the composition of the raw materials of the toner base particles was changed as follows. Subsequently, the toner base particles and an external additive were mixed in the same manner as in Example 1, whereby the toner of Example 4 was produced.

| | | |
|---|---|---|
| Amorphous polyester resin A2 | 72 | parts by mass |
| Amorphous polyester resin B2 | 8 | parts by mass |
| Crystalline polyester resin C | 10 | parts by mass |
| Release agent B | 3 | parts by mass |
| Carbon black | 6 | parts by mass |
| Charge control agent (polysaccharide | 1 | part by mass |
| inclusion compound containing Al and Mg) | | |

A toner of Example 5 was produced as follows.

First, toner base particles of Example 5 were produced in the same manner as in Example 1 except that the composition of the raw materials of the toner base particles was changed as follows. Subsequently, the toner base particles and an external additive were mixed in the same manner as in Example 1, whereby the toner of Example 5 was produced.

| | | |
|---|---|---|
| Amorphous polyester resin A2 | 76.5 | parts by mass |
| Amorphous polyester resin B2 | 8.5 | parts by mass |
| Crystalline polyester resin C | 5 | parts by mass |
| Release agent B | 3 | parts by mass |
| Carbon black | 6 | parts by mass |
| Charge control agent (polysaccharide | 1 | part by mass |
| inclusion compound containing Al and Mg) | | |

A toner of Example 6 was produced as follows.

First, toner base particles of Example 6 were produced in the same manner as in Example 1 except that the composition of the raw materials of the toner base particles was changed as follows. Subsequently, the toner base particles and an external additive were mixed in the same manner as in Example 1, whereby the toner of Example 6 was produced.

| | | |
|---|---|---|
| Amorphous polyester resin A1 | 76 | parts by mass |
| Amorphous polyester resin B1 | 4 | parts by mass |
| Crystalline polyester resin C | 10 | parts by mass |
| Release agent B | 3 | parts by mass |
| Carbon black | 6 | parts by mass |
| Charge control agent (polysaccharide | 1 | part by mass |
| inclusion compound containing Al and Mg) | | |

A toner of Example 7 was produced as follows.

First, toner base particles of Example 7 were produced in the same manner as in Example 1 except that the composition of the raw materials of the toner base particles was changed as follows. Subsequently, the toner base particles and an external additive were mixed in the same manner as in Example 1, whereby the toner of Example 7 was produced.

| | | |
|---|---|---|
| Amorphous polyester resin A1 | 64 | parts by mass |
| Amorphous polyester resin B3 | 16 | parts by mass |
| Crystalline polyester resin C | 10 | parts by mass |
| Release agent B | 3 | parts by mass |
| Carbon black | 6 | parts by mass |
| Charge control agent (polysaccharide | 1 | part by mass |
| inclusion compound containing Al and Mg) | | |

A toner of Example 8 was produced as follows.

First, toner base particles of Example 8 were produced in the same manner as in Example 1 except that the composition of the raw materials of the toner base particles was changed as follows. Subsequently, the toner base particles and an external additive were mixed in the same manner as in Example 1, whereby the toner of Example 8 was produced.

| | | |
|---|---|---|
| Amorphous polyester resin A1 | 76.5 | parts by mass |
| Amorphous polyester resin B1 | 8.5 | parts by mass |
| Crystalline polyester resin C | 5 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

A toner of Example 9 was produced as follows.

First, toner base particles of Example 9 were produced in the same manner as in Example 1 except that the composition of the raw materials of the toner base particles was changed as follows. Subsequently, the toner base particles and an external additive were mixed in the same manner as in Example 1, whereby the toner of Example 9 was produced.

| | | |
|---|---|---|
| Amorphous polyester resin A2 | 76.5 | parts by mass |
| Amorphous polyester resin B2 | 8.5 | parts by mass |
| Crystalline polyester resin C | 5 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

A toner of Example 10 was produced as follows.

First, toner base particles of Example 10 were produced in the same manner as in Example 1 except that the composition of the raw materials of the toner base particles was changed as follows. Subsequently, the toner base particles and an external additive were mixed in the same manner as in Example 1, whereby the toner of Example 10 was produced.

| | | |
|---|---|---|
| Amorphous polyester resin A2 | 78.3 | parts by mass |
| Amorphous polyester resin B2 | 8.7 | parts by mass |
| Crystalline polyester resin C | 3 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

A toner of Example 11 was produced as follows.

First, toner base particles of Example 11 were produced in the same manner as in Example 1 except that the composition of the raw materials of the toner base particles was changed as follows. Subsequently, the toner base particles and an external additive were mixed in the same manner as in Example 1, whereby the toner of Example 11 was produced.

| | | |
|---|---|---|
| Amorphous polyester resin A2 | 78.3 | parts by mass |
| Amorphous polyester resin B2 | 8.7 | parts by mass |
| Crystalline polyester resin C | 3 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

A toner of Example 12 was produced as follows.

First, toner base particles of Example 12 were produced in the same manner as in Example 1 except that the composition of the raw materials of the toner base particles was changed as follows. Subsequently, the toner base particles and an external additive were mixed in the same manner as in Example 1, whereby the toner of Example 12 was produced.

| | | |
|---|---|---|
| Amorphous polyester resin A2 | 80.8 | parts by mass |
| Amorphous polyester resin B2 | 4.2 | parts by mass |
| Crystalline polyester resin C | 5 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

A toner of Example 13 was produced as follows.

First, toner base particles of Example 13 were produced in the same manner as in Example 1 except that the composition of the raw materials of the toner base particles was changed as follows. Subsequently, the toner base particles and an external additive were mixed in the same manner as in Example 1, whereby the toner of Example 13 was produced.

| | | |
|---|---|---|
| Amorphous polyester resin A1 | 76 | parts by mass |
| Amorphous polyester resin B1 | 4 | parts by mass |
| Crystalline polyester resin C | 10 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

A toner of Example 14 was produced as follows.

First, toner base particles of Example 14 were produced in the same manner as in Example 1 except that the composition of the raw materials of the toner base particles was changed as follows. Subsequently, the toner base particles and an external additive were mixed in the same manner as in Example 1, whereby the toner of Example 14 was produced.

| | | |
|---|---|---|
| Amorphous polyester resin A4 | 68 | parts by mass |
| Amorphous polyester resin B3 | 17 | parts by mass |
| Crystalline polyester resin C | 5 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

A toner of Comparative Example 1 was produced as follows.

First, toner base particles of Comparative Example 1 were produced in the same manner as in Example 1 except that the composition of the raw materials of the toner base particles was changed as follows. Subsequently, the toner base particles and an external additive were mixed in the same manner as in Example 1, whereby the toner of Comparative Example 1 was produced.

| | | |
|---|---|---|
| Amorphous polyester resin A2 | 60 | parts by mass |
| Amorphous polyester resin B1 | 15 | parts by mass |
| Crystalline polyester resin C | 15 | parts by mass |
| Release agent B | 3 | parts by mass |
| Carbon black | 6 | parts by mass |
| Charge control agent (polysaccharide | 1 | part by mass |
| inclusion compound containing Al and Mg) | | |

A toner of Comparative Example 2 was produced as follows.

First, toner base particles of Comparative Example 2 were produced in the same manner as in Example 1 except that the composition of the raw materials of the toner base particles was changed as follows. Subsequently, the toner base particles and an external additive were mixed in the same manner as in Example 1, whereby the toner of Comparative Example 2 was produced.

| | | |
|---|---|---|
| Amorphous polyester resin A2 | 56 | parts by mass |
| Amorphous polyester resin B2 | 14 | parts by mass |
| Crystalline polyester resin C | 20 | parts by mass |
| Release agent B | 3 | parts by mass |
| Carbon black | 6 | parts by mass |
| Charge control agent (polysaccharide | 1 | part by mass |
| inclusion compound containing Al and Mg) | | |

A toner of Comparative Example 3 was produced as follows.

First, toner base particles of Comparative Example 3 were produced in the same manner as in Example 1 except that the composition of the raw materials of the toner base particles was changed as follows. Subsequently, the toner base particles and an external additive were mixed in the same manner as in Example 1, whereby the toner of Comparative Example 3 was produced.

| | | |
|---|---|---|
| Amorphous polyester resin A1 | 56 | parts by mass |
| Amorphous polyester resin B1 | 24 | parts by mass |
| Crystalline polyester resin C | 10 | parts by mass |
| Release agent B | 3 | parts by mass |
| Carbon black | 6 | parts by mass |
| Charge control agent (polysaccharide | 1 | part by mass |
| inclusion compound containing Al and Mg) | | |

A toner of Comparative Example 4 was produced as follows.

First, toner base particles of Comparative Example 4 were produced in the same manner as in Example 1 except that the composition of the raw materials of the toner base particles was changed as follows. Subsequently, the toner base particles and an external additive were mixed in the same manner as in Example 1, whereby the toner of Comparative Example 4 was produced.

| | | |
|---|---|---|
| Amorphous polyester resin A3 | 64 | parts by mass |
| Amorphous polyester resin B4 | 16 | parts by mass |
| Crystalline polyester resin C | 10 | parts by mass |
| Release agent B | 3 | parts by mass |
| Carbon black | 6 | parts by mass |
| Charge control agent (polysaccharide | 1 | part by mass |
| inclusion compound containing Al and Mg) | | |

A toner of Comparative Example 5 was produced as follows.

First, toner base particles of Comparative Example 5 were produced in the same manner as in Example 1 except that the composition of the raw materials of the toner base particles was changed as follows. Subsequently, the toner base particles and an external additive were mixed in the same manner as in Example 1, whereby the toner of Comparative Example 5 was produced.

| | | |
|---|---|---|
| Amorphous polyester resin A2 | 60 | parts by mass |
| Amorphous polyester resin B4 | 15 | parts by mass |
| Crystalline polyester resin C | 15 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

A toner of Comparative Example 6 was produced as follows.

First, toner base particles of Comparative Example 6 were produced in the same manner as in Example 1 except that the composition of the raw materials of the toner base particles was changed as follows. Subsequently, the toner base particles and an external additive were mixed in the same manner as in Example 1, whereby the toner of Comparative Example 6 was produced.

| | | |
|---|---|---|
| Amorphous polyester resin A3 | 68 | parts by mass |
| Amorphous polyester resin B4 | 17 | parts by mass |
| Crystalline polyester resin C | 5 | parts by mass |
| Release agent A | 3 | parts by mass |
| Carbon black | 6 | parts by mass |
| Charge control agent (polysaccharide | 1 | part by mass |
| inclusion compound containing Al and Mg) | | |

A method for measuring the glass transition temperature (Tg) of the amorphous polyester resins A and B is described.

The glass transition temperature (Tg) was measured by a DSC “DSC Q2000 (manufactured by TA Instruments, Inc.)”. The measurement conditions are as follows.

Sample amount: 5 mg

Lid and pan: alumina

Temperature raising rate: 10° C./min

Measurement method: The temperature of a sample is raised from 20° C. to 160° C. at a temperature raising rate of 10° C./min. Thereafter, the sample heated to 160° C. is cooled to 20° C. or lower. The sample is heated again, and a curved line observed in a temperature range from 30 to 60° C. is obtained. A tangent line is drawn in a curved portion on each of the low temperature side and the high temperature side of this curved line, and the temperature at the intersection point where the two tangent lines intersect each other was defined as the glass transition temperature (Tg).

A method for measuring the melting temperature (Tm) of the amorphous polyester resins A and B is described.

Each of the toners of the respective Examples was molded into a pellet form by applying a pressure using a compression machine. With respect to the pellet, the melting temperature (Tm) of the amorphous polyester resins A and B was measured using a flow tester “CFT-500D (manufactured by Shimadzu Corporation)” under the following conditions.

Measurement start temperature: 30° C.

Measurement end temperature: 200° C.

Load: 10 kgf

Temperature raising rate: 10° C./min

In the flow tester, a temperature corresponding to the midpoint (½) between the outflow start temperature at which melt outflow starts and the outflow end temperature at which all the sample is melted and flows out was defined as the melting temperature (Tm).

A method for measuring the melting point of the release agent and the crystalline polyester resin C is described.

The melting point of the release agent was measured by a DSC “DSC Q2000 (manufactured by TA Instruments, Inc.)”. The measurement conditions are as follows.

Sample amount: 5 mg

Lid and pan: alumina

Temperature raising rate: 10° C./min

Measurement method: The temperature of a sample is raised from 20° C. to 200° C. Thereafter, the sample is cooled to 20° C. or lower. The sample is heated again, and the maximum endothermic peak temperature measured in a temperature range from 55 to around 80° C. was defined as the melting point.

The melting point of the crystalline polyester resin C was also measured in the same manner as described above. However, the maximum endothermic peak temperature measured in a temperature range from 75 to around 120° C. when heating the sample again was defined as the melting point of the crystalline polyester resin C.

The release agent A corresponds to the ester wax α described in the embodiment. On the other hand, the release agent B does not correspond to the ester wax α described in the embodiment.

Synthesis of the release agent A which is an example of the ester wax α is described.

Into a four-neck flask equipped with a stirrer, a thermocouple, and a nitrogen introduction tube, 80 parts by mass of at least three or more types of long-chain alkyl carboxylic acids and 20 parts by mass of at least three or more types of long-chain alkyl alcohols were placed. An esterification reaction was performed at 220° C. under a nitrogen gas stream, whereby a reaction product was obtained. To the obtained reaction product, a mixed solvent of toluene and ethanol was added, thereby dissolving the reaction product. Further, a sodium hydroxide aqueous solution was added to the flask, and the resultant was stirred at 70° C. for 30 minutes. Further, the flask was left to stand for 30 minutes to separate the contents of the flask into an organic layer and an aqueous layer, and then, the aqueous layer was removed from the contents. Thereafter, ion exchanged water was added to the flask, and the resultant was stirred at 70° C. for 30 minutes. The flask was left to stand for 30 minutes to separate the contents of the flask into an aqueous layer and an organic layer, and then, the aqueous layer was removed from the contents. This operation was repeated five times. The solvent was distilled off from the organic layer in the contents of the flask under a reduced pressure condition, whereby an ester wax, that is, the release agent A was obtained.

The used long-chain alkyl carboxylic acids are as follows.
Palmitic acid (C₁₆H₃₂O₂)
Stearic acid (C₁₈H₃₆O₂)
Arachidonic acid (C₂₀H₄₀O₂)
Behenic acid (C₂₂H₄₄O₂)
Lignoceric acid (C₂₄H₄₈O₂)
Cerotic acid (C₂₆H₅₂O₂)
Montanic acid (C₂₈H₅₆O₂)

The used long-chain alkyl alcohols are as follows.
Palmityl alcohol (C₁₆H₃₄O)
Stearyl alcohol (C₁₈H₃₈O)
Arachidyl alcohol (C₂₀H₄₂O)
Behenyl alcohol (C₂₂H₄₆O)
Lignoceryl alcohol (C₂₄H₅₀O)
Ceryl alcohol (C₂₆H₅₄O)
Montanyl alcohol (C₂₈H₅₈O)

A method for measuring the carbon number distribution of the ester compounds (the proportion of each of the ester compounds with the corresponding carbon number) constituting the ester wax is described.

0.5 g of each of the toners of the respective Examples was weighed and placed in an Erlenmeyer flask. Subsequently, 2 mL of methylene chloride was added to the Erlenmeyer flask to dissolve the toner. Further, 4 mL of hexane was added to the Erlenmeyer flask to form a mixed liquid. The mixed liquid was filtered and separated into a filtrate and an insoluble material. The solvent was distilled off from the filtrate under a nitrogen gas stream, whereby a deposited material was obtained. With respect to the deposited material, the carbon number distribution of the ester compounds in the ester wax extracted from the toner was measured.

The proportion of each of the ester compounds with the corresponding carbon number was measured using FD-MS “JMS-T100GC (manufactured by JEOL Ltd.)”. The measurement conditions are as follows.

Sample concentration: 1 mg/mL (solvent: chloroform)

Cathode voltage: −10 kv

Spectral recording interval: 0.4 s

Measurement mass range (m/z): between 10 and 2000

The total ionic strength of the ester compounds with the corresponding carbon number obtained by the measurement was assumed to be 100. The relative value of the ionic strength of each of the ester compounds with the corresponding carbon number with respect to the total ionic strength was determined. The relative value was defined as the proportion of each of the ester compounds with the corresponding carbon number in the ester wax. Further, the carbon number of the ester compound with a carbon number, the relative value of which is highest, was denoted by C₁.

A method for analyzing the first monomer group and the second monomer group is described.

1 g of each ester wax was subjected to a methanolysis reaction under the condition of a temperature of 70° C. for 3 hours. The product after the methanolysis reaction was subjected to mass spectrometry using FD-MS, and the content of each of the long-chain alkyl carboxylic acids with the corresponding carbon number and the content of each of the long-chain alkyl alcohols with the corresponding carbon number were determined.

A method for measuring the carbon number distribution of each of the carboxylic acids constituting the first monomer group and the alcohols constituting the second monomer group is described.

The proportion of each of the carboxylic acids with the corresponding carbon number and the proportion of each of the alcohols with the corresponding carbon number were measured using FD-MS “JMS-T100GC (manufactured by JEOL Ltd.)”. The measurement conditions are as follows.

Sample concentration: 1 mg/mL (solvent: chloroform)

Cathode voltage: −10 kv

Spectral recording interval: 0.4 s

Measurement mass range (m/z): between 10 and 2000

The total ionic strength of the carboxylic acids with the corresponding carbon number obtained by the measurement was assumed to be 100. The relative value of the ionic strength of each of the carboxylic acids with the corresponding carbon number with respect to the total ionic strength was determined. The relative value was defined as the proportion of each of the carboxylic acids with the corresponding carbon number in the ester wax. Further, the carbon number of the carboxylic acid with a carbon number, the relative value of which is highest, was denoted by Cₙ.

Similarly, the total ionic strength of the alcohols with the corresponding carbon number obtained by the measurement was assumed to be 100. The relative value of the ionic strength of each of the alcohols with the corresponding carbon number with respect to the total ionic strength was determined. The relative value was defined as the proportion of each of the alcohols with the corresponding carbon number in the ester wax. Further, the carbon number of the alcohol with a carbon number, the relative value of which is highest, was denoted by Cₘ.

With respect to the release agent A, the carbon number distribution of the ester wax had only one maximum peak in a region where the carbon number is 43 or more. Further, the carbon number C₁ of the ester compound, the content of which is highest, was 44, the carbon number Cₙ of the carboxylic acid, the content of which is highest in the first monomer group, was 22, and the carbon number Cₘ of the alcohol, the content of which is highest in the second monomer group, was 22.

Developers of Examples are described.

With respect to 100 parts by mass of ferrite carrier, 9 parts by mass of each of the toners of the respective Examples was stirred using a Turbula mixer, whereby developers of the respective Examples were obtained.

A method for evaluating the low-temperature fixability at normal temperature is described.

Each of the developers of the respective Examples was left to stand overnight (for at least 8 hours or more) in a normal temperature environment, and thereafter stored in a toner cartridge. The toner cartridge was placed in an image forming apparatus for evaluating low-temperature fixability. The image forming apparatus for evaluating low-temperature fixability is an apparatus obtained by modifying the following two points from commercially available e-studio 6530c (manufactured by Toshiba Tec Corporation).
a point in which the fixing temperature can be set by changing the temperature by 0.1° C. at a time between 100° C. and 200° C.
a point in which the fixing speed can be changed and set

By using the image forming apparatus for evaluating low-temperature fixability, and setting the fixing temperature to 150° C. and the fixing speed to 75 mm/sec, 10 sheets of a solid image at a toner adhesion amount of 1.5 mg/cm² were obtained. Subsequently, by sequentially setting the fixing speed to 150 mm/sec and 225 mm/sec, 10 sheets of a solid image at a toner adhesion amount of 1.5 mg/cm² were obtained under the respective fixing speed conditions.

In the respective fixing speeds, when image peeling due to offset or unfixing did not occur on all the 10 sheets of the solid image, the fixing temperature was decreased by 5° C., and a solid image was obtained in the same manner as described above. This operation was repeated, and the lower limit temperature of the fixing temperature at which image peeling did not occur on the solid image was determined, and the lower limit temperature was defined as the lowest fixing temperature of the toner. When the lowest fixing temperature was 125° C. or lower, the low-temperature fixability at normal temperature was evaluated as pass (A). When the lowest fixing temperature was higher than 125° C., the low-temperature fixability at normal temperature was evaluated as fail (C).

A method for evaluating the low-temperature fixability in a high-temperature and high-humidity environment is described.

The lowest fixing temperature at each fixing speed was determined by the same method as the method for evaluating the low-temperature fixability at normal temperature except that each of the developers of the respective Examples was left to stand overnight (for at least 8 hours or more) in an environment at a temperature of 30° C. and a humidity of 85%, and thereafter stored in a toner cartridge. When the lowest fixing temperature was 125° C. or lower, the low-temperature fixability in a high-temperature and high-humidity environment was evaluated as pass (A). When the lowest fixing temperature was higher than 125° C., the low-temperature fixability in a high-temperature and high-humidity environment was evaluated as fail (C).

A method for evaluating the chargeability in a high-temperature and high-humidity environment is described.

100 g of each of the developers of the respective Examples was put in a bottle made of polyethylene, and left to stand overnight (for at least 8 hours or more) in an environment at a temperature of 30° C. and a humidity of 85%. Thereafter, the developer was stirred for 5 minutes using a Turbula mixer, and immediately thereafter, the charge amount was measured using a suction blow-off device. When the value of the charge amount was −6.0 μC/g or less, the chargeability was evaluated as pass (A). When the value of the charge amount was within a range of more than −6.0 μC/g and −3.0 μC/g or less, the chargeability was evaluated as pass (B). When the value of the charge amount was more than −3.0 μC/g, the chargeability was evaluated as fail (C).

A method for evaluating the storage stability is described.

Each of the toners of the respective Examples was left at 55° C. for 10 hours. 15 g of each of the toners of the respective Examples after being left at 55° C. for 10 hours was sieved through a mesh with an opening of 355 μm, and the toner remaining on the mesh was weighed. As the amount of the toner remaining on the mesh is smaller, the storage stability is superior. When the amount of the toner remaining on the mesh was 3 g or less, the storage stability of the toner was evaluated as pass (A). When the amount of the toner remaining on the mesh was within a range of more than 3 g and 5 g or less, the storage stability of the toner was evaluated as pass (B). When the amount of the toner remaining on the mesh was more than 5 g, the storage stability of the toner was evaluated as fail (C).

The evaluation results of the low-temperature fixability at normal temperature, the low-temperature fixability in a high-temperature and high-humidity environment, the chargeability, and the storage stability of the toners of the respective Examples are shown in Tables 1 and 2.

TABLE 1

| | | | | | | | Low-temperature | | |
|---|---|---|---|---|---|---|---|---|---|
| | | | | | | Low-temperature | fixability in | | |
| | | | | | | fixability at | high-temperature | | |
| | Tg | Tm | a | b | c | normal | and high-humidity | | Storage |
| | [° C.] | [° C.] | [mass %] | [mass %] | [mass %] | temperature | environment | Chargeability | stability |
| Example 1 | 50 | 135 | 80 | 20 | 10 | A | A | A | A |
| Example 2 | 48 | 145 | 80 | 20 | 10 | A | A | A | A |
| Example 3 | 48 | 145 | 85 | 15 | 10 | A | A | A | A |
| Example 4 | 48 | 145 | 90 | 10 | 10 | A | A | A | A |
| Example 5 | 48 | 145 | 90 | 10 | 5 | A | A | A | A |
| Example 6 | 50 | 135 | 95 | 5 | 10 | A | A | A | B |
| Example 7 | 50 | 120 | 80 | 20 | 10 | A | A | A | B |
| Comparative | 48 | 135 | 80 | 20 | 15 | A | C | A | A |
| Example 1 | | | | | | | | | |
| Comparative | 48 | 145 | 80 | 20 | 20 | A | C | C | A |
| Example 2 | | | | | | | | | |
| Comparative | 50 | 135 | 70 | 30 | 10 | C | C | A | A |
| Example 3 | | | | | | | | | |
| Comparative | 54 | 130 | 80 | 20 | 10 | C | C | A | A |
| Example 4 | | | | | | | | | |

TABLE 2

| | | | | | | | Low-temperature | | |
|---|---|---|---|---|---|---|---|---|---|
| | | | | | | Low-temperature | fixability in | | |
| | | | | | | fixability at | high-temperature | | |
| | Tg | Tm | a | b | c | normal | and high-humidity | | Storage |
| | [° C.] | [° C.] | [mass %] | [mass %] | [mass %] | temperature | environment | Chargeability | stability |
| Example 8 | 50 | 135 | 90 | 10 | 5 | A | A | A | A |
| Example 9 | 48 | 145 | 90 | 10 | 5 | A | A | A | A |
| Example 10 | 48 | 145 | 95 | 5 | 3 | A | A | A | A |
| Example 11 | 48 | 145 | 90 | 10 | 3 | A | A | A | A |
| Example 12 | 48 | 145 | 95 | 5 | 5 | A | A | A | A |
| Example 13 | 50 | 135 | 95 | 5 | 10 | A | A | B | B |
| Example 14 | 41 | 120 | 80 | 20 | 5 | A | A | A | B |
| Comparative | 48 | 130 | 80 | 20 | 15 | A | C | C | A |
| Example 5 | | | | | | | | | |
| Comparative | 54 | 130 | 80 | 20 | 5 | C | C | A | A |
| Example 6 | | | | | | | | | |

In Tables 1 and 2, Tg is the glass transition temperature of the amorphous polyester resin A. Tm is the melting temperature of the amorphous polyester resin B. a is the proportion of the amorphous polyester resin A with respect to 100 mass % of the amorphous polyester resin component. b is the proportion of the amorphous polyester resin B with respect to 100 mass % of the amorphous polyester resin component. c is the proportion of the crystalline polyester resin component with respect to 100 mass % of the toner base particles.

The toners of Examples 1 to 14 showed favorable evaluation results with respect to all the low-temperature fixability at normal temperature, the low-temperature fixability in a high-temperature and high-humidity environment, and the chargeability. Further, the toners of Examples 1 to 5 also had excellent storage stability.

On the other hand, the toners of Comparative Examples 1 to 6 did not simultaneously meet the pass criteria for all the low-temperature fixability at normal temperature, the low-temperature fixability in a high-temperature and high-humidity environment, and the chargeability.

In any of the toners of Examples 8 to 12, and 14, the proportion of the crystalline polyester resin component with respect to 100 mass % of the toner base particles is 5 mass % or less. Therefore, the chargeability in a high-temperature and high-humidity environment of the toners was more favorable than that of the toners of Examples 1 to 7. In Example 14, the storage stability was poor as compared with the other Examples, but was at a level sufficient for practical use.

While certain embodiments of the invention have been described, these embodiments have been presented by way of example only, and are not intended to limit the scope of the invention. The embodiments described herein may be embodied in various other forms, and various omissions, substitutions, and changes may be made without departing from the gist of the invention. The embodiments and modifications thereof are included in the scope and gist of the invention and also included in the invention described in the claims and in the scope of their equivalents.

What is claimed is:

1. A toner comprising:
toner base particles comprising a crystalline polyester resin component and an amorphous polyester resin component, wherein
the amorphous polyester resin component comprises at least two or more types of multiple amorphous polyester resins,
the glass transition temperature of an amorphous polyester resin A, the content of which is highest in the multiple amorphous polyester resins, is 52° C. or lower,
the melting temperature of an amorphous polyester resin B, which is at least one type of the multiple amorphous polyester resins other than the amorphous polyester resin A, is 100° C. or higher,
the proportion of the amorphous polyester resin A is 80 mass % or more with respect to 100 mass % of the amorphous polyester resin component,
the proportion of the amorphous polyester resin B is 20 mass % or less with respect to 100 mass % of the amorphous polyester resin component, and
the proportion of the crystalline polyester resin component is 10 mass % or less with respect to 100 mass % of the toner base particles.

2. The toner according to claim 1, wherein the proportion of the amorphous polyester resin A is 90 mass % or less with respect to 100 mass % of the amorphous polyester resin component.

3. The toner according to claim 1, wherein the proportion of the amorphous polyester resin B is 10 mass % or more with respect to 100 mass % of the amorphous polyester resin component.

4. The toner according to claim 1, wherein the proportion of the crystalline polyester resin component is 5 mass % or less with respect to 100 mass % of the toner base particles.

5. The toner according to claim 4, wherein the proportion of the amorphous polyester resin A is 90 mass % or more with respect to 100 mass % of the amorphous polyester resin component.

6. The toner according to claim 4, wherein the proportion of the amorphous polyester resin B is 10 mass % or less with respect to 100 mass % of the amorphous polyester resin component.

7. The toner according to claim 4, wherein the melting temperature of the amorphous polyester resin B is 130° C. or higher.

8. The toner according to claim 4, wherein the proportion of the amorphous polyester resin A is 95 mass % or less with respect to 100 mass % of the amorphous polyester resin component.

9. The toner according to claim 4, wherein the proportion of the amorphous polyester resin B is 5 mass % or more with respect to 100 mass % of the amorphous polyester resin component.

10. The toner according to claim 1, wherein the glass transition temperature of the amorphous polyester resin A is between 42 and 52° C.

11. The toner according to claim 1, wherein the amorphous polyester resin A has a mass average molecular weight of between 5×10³ and 9×10³.

12. The toner according to claim 1, wherein the melting temperature of the amorphous polyester resin B is between 100° C. and 160°.

13. The toner according to claim 1, wherein the amorphous polyester resin B has a mass average molecular weight of between 1×10⁴ and 9×10⁴.

14. The toner according to claim 1, wherein the crystalline polyester resin component has a melting point of between 60 and 120° C.

15. The toner according to claim 1, wherein the crystalline polyester resin component has a mass average molecular weight of between 6.0×10³ and 1.8×10⁴.

16. A toner cartridge comprising a container comprising the toner according to claim 1.

17. An image forming apparatus comprising the toner cartridge according to claim 16.
